(19) United States
(12) Patent Application Publication
(10) Pub. No.: US 2022/0151208 A1
(43) Pub. Date: May 19, 2022

(54) CONFIGURATION APPLIED TO AN ELEMENT FOR FASTENING OYSTERS

(71) Applicant: Paulo Ferreira Trotta, Rio De Janeiro (BR)

(72) Inventor: Paulo Ferreira Trotta, Rio De Janeiro (BR)

(21) Appl. No.: 17/435,274

(22) PCT Filed: Mar. 13, 2020
(86) PCT No.: PCT/BR2020/000008

§ 371 Date: Aug. 31, 2021

(30) Foreign Application Priority Data
Mar. 14, 2019 (BR) 1020190049626

(51) Int. Cl. A01K 61/54; A01K 61/60

(52) U.S. Cl. CPC A01K 61/54; A01K 61/60

(57) ABSTRACT

Patent for structure used in oyster cultivation, wherein the invention comprises a base (1), having four holes (2), where four pins are fixed, fixing the base to the bottom of the sea, base (1) has four other holes, wherein four vertical tubes (3) are fixed; after fixing tubes (3) to the base (1) of the structure, box (4) is settled over base (1), using tubes (3) as guides; afterwards, after putting oysters seeds in box (4), lid (5) is fixed over box (4), followed by sealing of lid (5), installed over box (4), in a way to avoid strange elements to the cultivation to access the oysters, then one end of rope (7) is fixed to ring (6) present in lid (5) and then the other end of rope (7) is fixed to counterweight (9), after passing this end of rope (7) by the hole present in buoy (8) (ring (6), fixed to one end of rope (7), buoy (8), counterweight (9), fixed to the other end of rope (7), help to maintain the structure stable in vertical position at the bottom of the sea during tide variations as well as during any sea turbulence at the cultivation location.

The present patent description refers to a structure used for oysters cultivation.

Oyster cultivation in Brazil and other countries is performed in cylindrical baskets, that basically consists of cylinders, with lateral surfaces formed of plastic screen, in netting form, divided in layers by parallel planes the cylinders bases, 15 centimeters apart from each other. The access to cylinders layers is performed by cylinder lateral, through an opening sealed by velcro, the opening being vertical and parallel to cylinder axis.

A drawback of this type of cultivation is the fact that sea pollution blocks the netting forming the cylinder lateral surface, demanding periodic cleaning of the cylinder baskets

Another drawback is that oyster cultivation in cylindrical baskets cannot be done near mussel cultivation, since mussel cultivation demand a large amount of impurities, which blocks the cylindrical baskets netting.

A further drawback is the fact that cylindrical baskets have as single sealing against the access of unauthorized people the lateral surface Velcro sealing. This enables malicious people to access the oysters, causing damages to the farmers.

Aiming to solve such drawbacks, the present invention was developed, comprising the following elements: Base (1), having four holes (2), through which the base (1) is fixed to the bottom of the sea. Base (1) has four other holes, wherein four vertical tubes (3) are fixed, serving as the guide(s) for settlement of box(es) on base (1), after the oysters seed are put in these boxes; Lid (5), having a ring (6), fixing one of the ends of rope (7). The other end of rope (7), after passing through the hole of buoy (8), is fixed to counterweight (9). Ring (6), rope (7) and buoy (8) and counterweight (9), interconnected, help to maintain the structure in vertical position at the bottom of the sea during tide variations as well as during any sea turbulence at the cultivation location.

The invention will be better understood by means of the detailed description in accord with the attached figures.

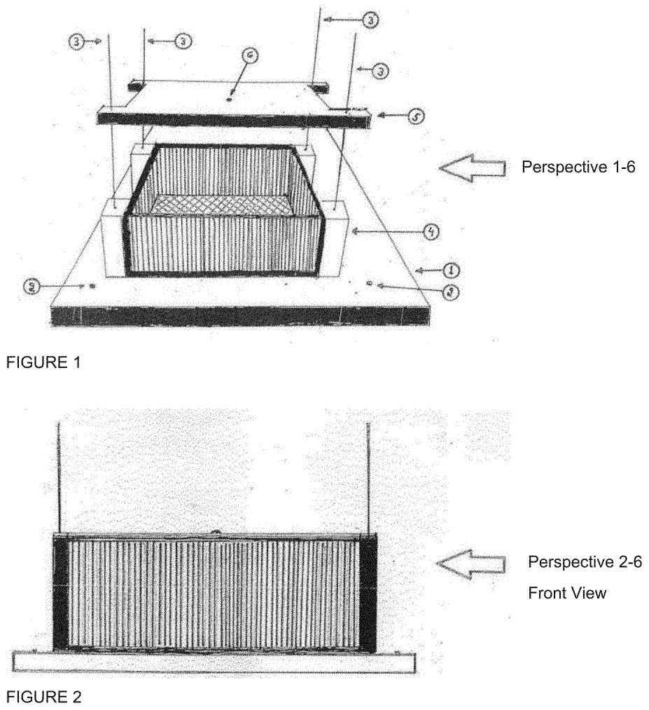

FIG. 1 represents a view of the structure object of the invention, having a single box (4).

FIG. 2 represents the front view of the structure object of the invention, having a single box (4).

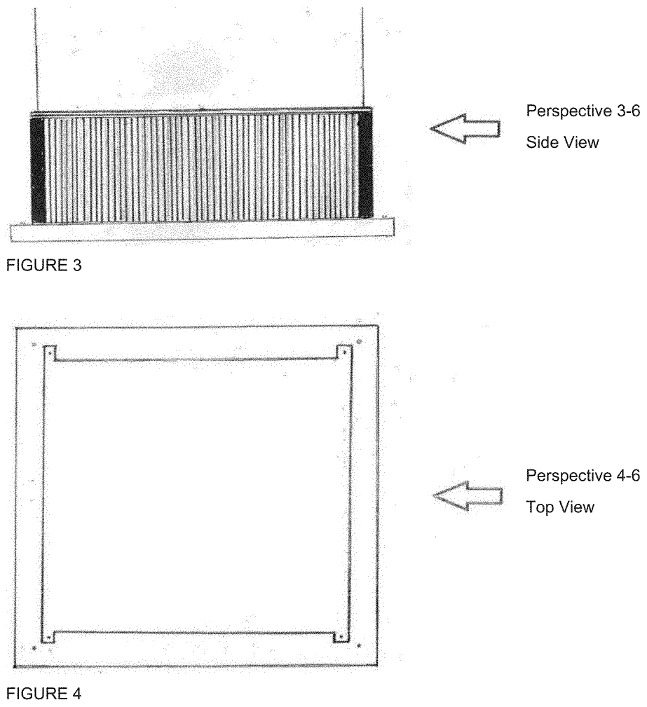

FIG. 3 represents the side view of the structure object of the invention, having a single box (4).

FIG. 4 represents the top view of the structure object of the invention.

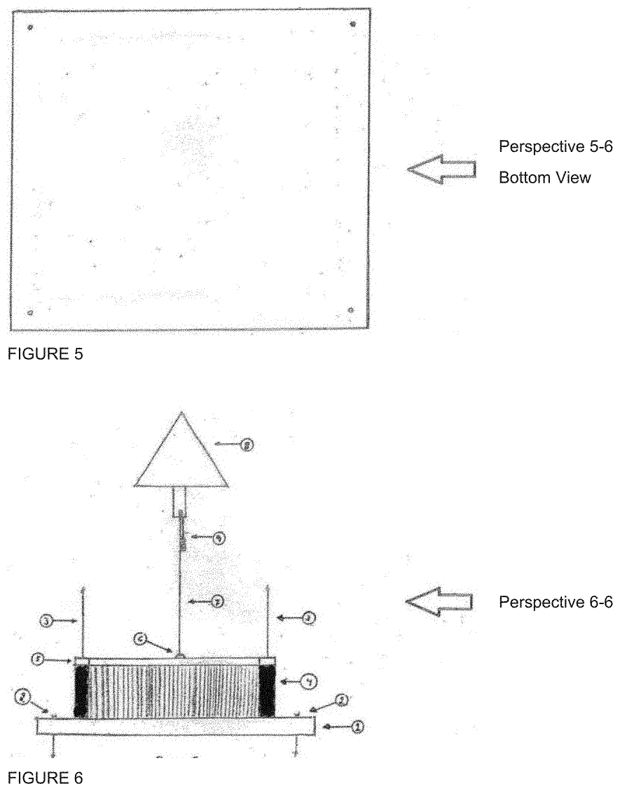

FIG. 5 represents the bottom view of the structure object of the invention.

FIG. 6 presents the structure object of the invention, having a single box (4), with its constitutive elements interconnected.

The installation of the structure at the sea follows the following steps: First) the base (1) is launched at sea; Second) base (1) is fixed to the bottom of the sea through pins installed in holes (2); Third) tubes (3) are fixed in the other four holes of base (1); Fourth) Settlement of box (4) to base (1) of the structure, using tubes (3) as guides; Fifth) Settlement of lid (5) on the box (4), after insertion of oyster seeds inside box (4); Sixth) sealing of lid (5), to avoid strange elements to the cultivation to access the oysters; Seventh) Fixing one of the ends of rope (7) to ring (6) of lid (5); Eighth) Fixing the other end of rope (7) to counterweight (9) after passing it through the hole of buoy (8). Ring (6), fixed to rope (7), buoy (8) and the counterweight (9), fixed to the other end of rope (7), help to maintain the structure stable in vertical position at the bottom of the sea. The structure can have a greater number of boxes (4), being the lid (5) settled only in the last box.

1-3. (canceled)

4. Device for oyster cultivation comprising:
a base (1) with means for attachment to the bottom of the sea;
at least one box (4) configured to hold oyster seeds; and
a lid (5) placed on top of the at least one box (4); characterized by
the at least one box (4) being removable from the base (1); and the device further comprising:
vertical tubes (3) fixed to the base (1) and configured to serve as guide for settlement of the at least one box (4) on the base (1).

5. A device according to claim 4, further comprising:
a buoy (8); and
a rope (7) with one end attached to the lid (5) and another end attached to a counterweight (9), after passing through a hole in the buoy (8).

6. A device according to claim 5, wherein the rope (7) is attached to the lid (5) by passing through a ring (6) attached to the lid (5).

7. A device according to claim 4, wherein the at least one box (4) comprises lateral surfaces formed of a plastic screen in netting form.

8. A device according to claim 4, wherein the means for attachment to the bottom of the sea of base (1) is comprised of a plurality of holes (2) and pins that pass through said holes (2).

9. A device according to claim 4, wherein when there are two or more boxes (4), the boxes (4) are stacked on top of each other, and the lid (5) is put only on top of the top box (4).

10. A device according to claim 4, wherein the lid (5) is sealed on top of the box (4).

11. A method for oyster cultivation characterized by comprising the steps of:
a) inserting oyster seeds inside at least one box (4) configured to hold oyster seeds;
b) positioning the at least one box (4) at the bottom of the sea; and
c) closing the at least one box (4) with a lid (5); wherein the lid (5) has a rope (7) with one end attached to a ring (6) on the lid and another end attached to a counterweight (9), after passing through a hole in a buoy (8); characterized in that
the at least one box (4) is placed over a base (1) with the help of vertical tubes (3) fixed to the base (1).

12. A method according to claim 11, comprising placing two or more boxes (4) over the base (1) with the help of the vertical tubes (3), the boxes (4) being stacked on top of each other, and the lid (5) put only on top of the top box (4).

13. A method according to claim 11, wherein before placement of the at least one box (4) the base (1) is fixed to the bottom of the sea.

14. A method according to claim 13, wherein the base (1) is fixed to the bottom of the sea by through pins installed in holes (2) in the base (1).
